(19) United States
(12) Patent Application Publication
(10) Pub. No.: US 2004/0257499 A1
(43) Pub. Date: Dec. 23, 2004

(54) Liquid crystal display module with backlight

(76) Inventors: Jui-Jen Yueh, Ping Chen City (TW); Hsien-Lin Lee, Ping Chen City (TW); Shih-Hao Wen, Ping Chen City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 10/805,128

(22) Filed: Mar. 19, 2004

(30) Foreign Application Priority Data
Jun. 17, 2003 (TW) 92211048

(51) Int. Cl. G02F 1/1335

(52) U.S. Cl. 349/106

(57) ABSTRACT

A back light LCD module has an upper glass substrate and a lower glass substrate. A layer of color filter is deposited on both the upper glass substrate and the lower glass substrate. The color filter has a plurality of color layers and black matrixes. The color layer includes red layer, green layer, and blue layer. A protection layer and a conductive layer are sequentially deposited on both color filters. The liquid crystal material fills between the upper and lower conductive layers.

### BACKGROUND OF THE INVENTION

1. Field of Invention

The present invention relates to an LCD module. More particularly, the present invention relates to a high-color purity LCD module with backlight.

2. Description of Related Art

A display is now an essential tool for information exchange. There are several kinds of manufacturing methods for display, such as CRT displays and LCDs.

Conventional CRT displays have been fully developed in manufacturing technology and various applications. A CRT provides a color display in a television set. However, CRTs can't used in some applications, such as notebook PC displays and PDA displays, because CRTs are large and heavy. The LCD has replaced CRT displays in various fields because they are smaller and lighter.

In a color LCD module, the liquid crystal cannot itself emit colored light. Color filters produce a color display when a light beam passes therethrough. Because increasing numbers of LCD applications need high-color display, such as LCD television, high-contrast color displays are in great demand. However, conventional red, green, and blue color layer materials are incapable of providing high color display.

### SUMMARY OF THE INVENTION

It is therefore an objective of the present invention to provide to a high-colored LCD module with a backlight.

In accordance with the foregoing and other objectives of the present invention, a back light LCD module includes an upper glass substrate and a lower glass substrate. A layer of color filter is deposited on both the upper glass substrate and the lower glass substrate. The color filter includes a plurality of color layer and black matrixes. The color layers include red color layers, green color layers, and blue color layers. A protection layer and a conductive layer are sequentially deposited on both color filters. The liquid crystal material is filled between upper and lower conductive layers.

According to one preferred embodiment of the present invention, the color layer thickness is from about 0.1 μm to 4.0 μm. The color layer can be deposited on the upper glass substrate and the lower glass substrate with the same or different thicknesses according to demand. The layout pattern of color layers includes strip pattern, triangle pattern and mosaic pattern.

According to another preferred embodiments of present invention, the color layer thickness is from about 0.1 μm to 4.0 μm. Only one color layer can be deposited on the upper glass substrate and the lower glass substrate and the other color layers are replaced by a compensatory layer. The layout pattern of the color layers include a strip pattern, a triangle pattern and a mosaic pattern.

In general, an LCD module with backlight can provide a high-contrast color display. Moreover, two color layers with different film thicknesses can be deposited on upper and lower substrates or only one color layer can be deposited on both substrates according to demand.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a perspective view of an LCD module with backlight according to one preferred embodiment of this invention;

FIG. 2 illustrates a cross-sectional view of a color filter according to one preferred embodiment of this invention;

FIG. 3 is illustrates a cross-sectional view of a color filter according to another preferred embodiment of this invention; and

FIGS. 4A, 4B and 4C respectively illustrates three kinds of layout patterns for color layers.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to meet the demand for high color LCD, color filters are formed on both glass substrates of an LCD module. The present invention provides high-contrast by means of two layers of color layers.

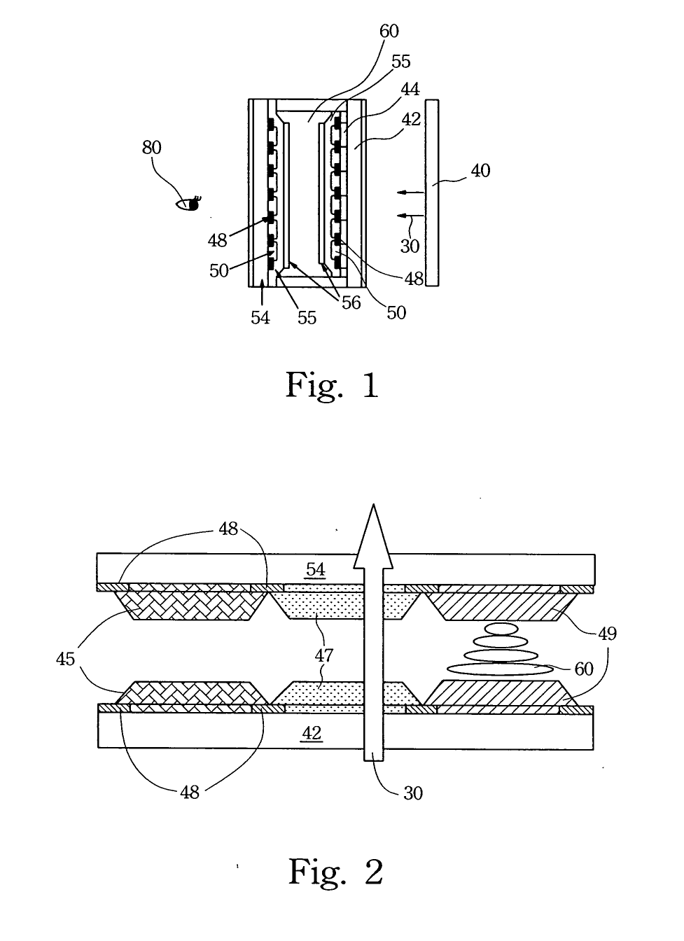

FIG. 1 illustrates a perspective view of an LCD module with backlight according to one preferred embodiment of this invention. An LCD module with backlight has only one light source: backlight. For example, a backlight source 40 emits backlight 30 though glass substrate such that an observer's eye 80 can see the image. In one preferred embodiment of this invention, color filters are respectively deposited on both glass substrates. The color filter consists of color layers 50 and black matrixes 48. The color layers 50 include red, green and blue. The LCD displays different color when light passes through different color layers. For example, The LCD displays red color when light passes through red color layers. In order to display high-contrast color, the light source needs to go through more layers of color layers. Therefore, color filters are deposited on both glass substrate 54 and glass substrate 42, rather than the color filter being deposited on glass substrate 54 and a layer of thin film transistor 44 being deposited on glass substrate 42. The color layer can be deposited on the glass substrate 42 and the glass substrate 54 with the same or different thicknesses according demands. The preferred layer thickness is about 0.1 to 4.0 μm.

Referring to FIG. 1, a complete LCD module includes thin film transistor 44, color filters (color layers 50 and black matrixes 48) on two glass substrates, protective layer 55, conductive layer 56 and liquid crystal materials 60. The thin film transistor 44 is employed to control liquid crystal materials 60. Color filters provide the LCD with high-contrast color. The protective layer 55 formed upon the color layers 50 and black matrixes 48 is employed to isolate liquid crystal materials 60. The conductive layer 56 is a conductive interface between thin film transistor 44 and liquid crystal materials 60.

FIG. 2 illustrates a cross-sectional view of a color filter according to one preferred embodiment of this invention. In order to describe present invention in detail, FIG. 2 illustrates an enlarged view of the color filter, but omits other layers, such as the protective layer, conductive layer and thin film transistors. Backlight 30 travels through the glass substrate 42, the color filter, the liquid crystal material layer 60, the color filter, and the glass substrate 54 toward the outside. In one preferred embodiment, the color layers consist of red layers 45, green layers 47 and blue layers 49. The color layer pattern can be arranged in strip patterns (illustrated in FIG. 4A), triangle patterns (illustrated in FIG. 4B) or mosaic patterns (illustrated in FIG. 4C). The same color layer pattern should be arranged in corresponding positions of both-side glass substrate. For example, red layers should be arranged in corresponding positions of both-side glass substrate. The color layer can be deposited on the glass substrate 42 and the glass substrate 54 with the same or different thicknesses according to demands. The preferred layer thickness is about 0.1 to 4.0 μm. The black matrix is an opaque material, used to prevent the light from traveling through the gap between the color layers.

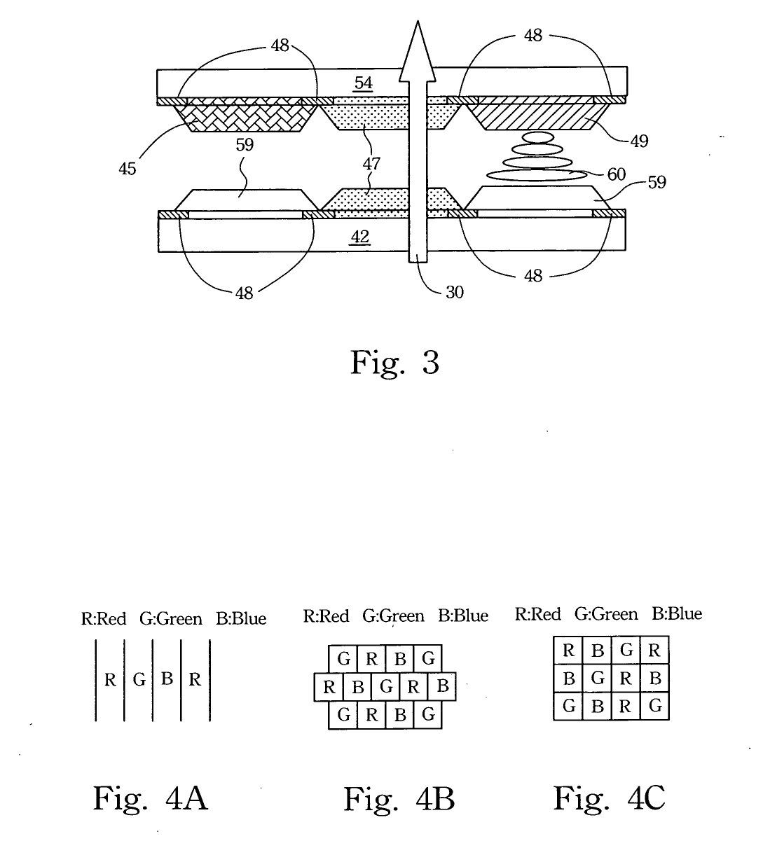

FIG. 3 illustrates a cross-sectional view of color filter according to another preferred embodiment of this invention. In this preferred embodiment of present invention, only one color is specially processed to be high-contrast color. For example, only green color layer 47 is specially processed to be high-contrast color. The red layer 45 and the blue layer 49 are not deposited on the glass substrate 42; instead, a compensatory layer 59 is used to replace the red layer 45 and the blue layer 49. The color layer can be deposited on the glass substrate 42 and the glass substrate 54 with the same or different thicknesses according to demands. The preferred layer thickness is about 0.1 to 4.0 μm.

According to preferred embodiments of present invention, an LCD module with backlight can provide high-contrast color display. Moreover, two color layers with different film thicknesses can be deposited on upper and lower substrates or only one color layer can be deposited on both substrates according to demands.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An LCD module with backlight including an upper glass substrate and a lower glass substrate, said LCD module comprising:
a plurality of first color layers formed upon the upper glass substrate and a plurality of first black matrixes formed in gaps between said first color layers;
an upper protective layer, covering said first color layers and said first black matrixes;
an upper conductive layer, covering said upper protective layer;
a plurality of thin film transistors formed on the lower glass substrate;
a plurality of second color layers formed upon said thin film transistors and a plurality of second black matrixes formed in gaps between said second color layers, wherein a color of each said second color layers is identical to a color of each corresponding said first color layers;
a lower protective layer, covering said second color layers and said second black matrixes;
a lower conductive layer, covering said lower protective layer; and
a liquid crystal material layer, positioned between said lower conductive layer and said upper conductive layer.

2. The LCD module of claim 1, wherein said first color layers include red color layers, green color layers and blue color layers.

3. The LCD module of claim 1, wherein a thickness of said first color layers is about 0.1 μm to 4.0 μm.

4. The LCD module of claim 1, wherein said second color layers include red color layers, green color layers and blue color layers.

5. The LCD module of claim 1, wherein at least one of said second color layers is selected from a group consisting of a red color layer, a green color layer and a blue color layer.

6. The LCD module of claim 1, wherein a thickness of said second color layer is about 0.1 μm to 4.0 μm.

7. The LCD module of claim 1, wherein said first color layers and said second color layers are of an identical thickness.

8. The LCD module of claim 1, wherein said first color layers and said second color layers are of different thicknesses.

9. The LCD module of claim 1, wherein a layout pattern of said first color layers includes a strip pattern, a triangle pattern and an mosaic pattern.

10. The LCD module of claim 1, wherein a layout pattern of said second color layers includes a strip pattern, a triangle pattern and an mosaic pattern.

11. An LCD module with backlight including an upper glass substrate and a lower glass substrate, said LCD module comprising:
a plurality of first color layers formed upon the upper glass substrate and a plurality of first black matrixes formed in gaps between said first color layers;
an upper protective layer, covering said first color layers and said first black matrixes;
an upper conductive layer, covering said upper protective layer;
a plurality of thin film transistors formed on the lower glass substrate;
a plurality of second color layers and compensatory layers formed upon said thin film transistors and a plurality of second black matrixes formed in gaps between said second color layers, wherein a color of each said second color layers is identical to a color of each corresponding said first color layers;
a lower protective layer, covering said second color layers and said second black matrixes;
a lower conductive layer, covering said lower protective layer; and
a liquid crystal material layer, positioned between said lower conductive layer and said upper conductive layer.

12. The LCD module of claim 11, wherein said first color layers include red color layers, green color layers and blue color layers.

13. The LCD module of claim 11, wherein a thickness of said first color layers is about 0.1 μm to 4.0 μm.

14. The LCD module of claim 11, wherein at least one of said second color layers is selected from a group consisting of a red color layer, a green color layer and a blue color layer.

15. The LCD module of claim 11, wherein a thickness of said second color layer is about 0.1 μm to 4.0 μm.

16. The LCD module of claim 11, wherein said first color layers and said second color layers are of an identical thickness.

17. The LCD module of claim 11, wherein said first color layers and said second color layers are of different thicknesses.

18. The LCD module of claim 11, wherein a layout pattern of said first color layers includes a strip pattern, a triangle pattern and an mosaic pattern.
